(19) United States
(12) Patent Application Publication
(10) Pub. No.: US 2003/0034602 A1
(43) Pub. Date: Feb. 20, 2003

(54) Universal holding fixture

(76) Inventor: Chris J. Kavanaugh, San Clemente, CA (US)

Correspondence Address: Kenneth W. Float, The Law Offices of Kenneth W. Float, P.O. Box 80790, Rancho Santa Margarita, CA, 92688, US

(21) Appl. No.: 09/932,018

(22) Filed: Aug. 18, 2001

(51) Int. Cl. B25B 1/20

(52) U.S. Cl. 269/45

(57) ABSTRACT

Universal holding fixtures or tools for holding oddly shaped objects or workpieces. The universal holding fixtures hold an object or workpiece having any shape and allows orientation of the object or workpiece so that all sides may be easily viewed and worked on. The universal holding fixtures comprise a plurality of dual axis clamps that are interconnected by way of rods to form an articulated structure. The dual axis clamps are individually moveable along the rods, are rotatable with respect to the rods, and are lockable to the rods to which they are connected. A preferred embodiment of the universal holding fixture has a base to which a plurality of clamps are secured that are interconnected by a fixed rod. The articulated structure is rotatably coupled to the fixed rod and is articulated relative to the fixed rod and the base so that distal ends of selected rods secured by the dual axis rotatable clamps are positioned to hold and/or support the object or workpiece. Once the object or workpiece is held in a desired manner by the selected rods, the dual axis clamps may be tightened to secure the rods in a locked position.

### BACKGROUND

The present invention relates generally to tooling, and more particularly, to universal holding fixtures or tools, especially for use in holding oddly shaped workpieces without using a specially-made fixture.

Often times, hobbyists are required to hold objects or workpieces in order to build or paint them. For example, model boats that are miniaturized examples of multi-masted sailing ships are often constructed from kits that require assembly and painting to finish the work. Such workpieces along with model planes and automobiles, for example, are oddly shaped and are difficult to hold. The present invention provides for a solution to this problem.

Typically what is done when holding a model boat, for example, is to drill holes in the bottom of the hull and insert dowel pins into the holes. A base is made having mating holes that hold the dowel pins and boat in an upright, level position. This requires additional work and does not allow the boat to be oriented at other positions without drilling other holes.

Other oddly shaped objects or workpieces such as egg shells that are carved or painted, airplane fuselages, or electronic devices, for example, often must be held in a manner so that a worker can work with the object or workpiece using both hands. Typically, these objects or workpieces cannot be easily held in a vise while work is performed. For example, vehicle engines and components, components that must be welded, and other larger sized objects and components that require holding during manufacture, assembly, painting and the like, require a fixture that can adequately hold them notwithstanding their uneven shapes.

Accordingly, it is an objective of the present invention to provide for universal holding fixtures for use in holding oddly shaped objects or workpieces without requiring the use of a specially-made fixture.

### SUMMARY OF THE INVENTION

The present invention provides for improved universal holding fixtures. The universal holding fixtures are designed to hold an object or workpiece having any shape and allows orientation of the workpiece so that all sides of the object or workpiece may be easily viewed and worked on.

The universal holding fixtures comprise a plurality of dual axis rotatable clamps that are interconnected by way of rods to form an articulated structure. The dual axis rotatable clamps are individually moveable or slidable along the rods, are individually rotatable around the rods, and are individually lockable or securable to the rods to which they are connected. Loosening of selected dual axis clamps, rotating and translating selected rods relative to the dual axis clamps and retightening the dual axis clamps provides for positioning of the ends of the rods that are used to hold the object or workpiece in a desired position and orientation.

A preferred embodiment of the universal holding fixture comprises a base to which a plurality of clamps are secured that are interconnected by a fixed rod secured by the clamps. The articulated structure is coupled to the fixed rod and is articulated relative to the fixed rod and the base such that selected ones of the rods secured by the dual axis rotatable clamps are positioned to hold an object or workpiece. Once the object or workpiece is held by the rods of the articulated structure, the dual axis rotatable clamps are secured or clamped to the rods. Clamps may be loosened to rotate the rods to any desired angle or orientation to allow the object or workpiece to be secured in a desired position.

An exemplary embodiment of the articulated structure comprises a plurality of first dual axis clamps to which the fixed rod is slidably secured and that each have a second rod transversely extending therefrom that is secured thereby. A second dual axis clamp is slidably secured to each of the second rods. Each second dual axis clamp slidably secures a third rod that is disposed generally transverse to the second rod secured thereby. A third dual axis clamp is slidably secured to each of the third rods. Each third dual axis clamp slidably secures a fourth rod that is disposed generally transverse to the third rod secured thereby. A fourth dual axis clamp is slidably secured to each of the fourth rods. The fourth dual axis clamps are slidably secured to a fifth rod.

Optional fifth dual axis clamps are slidably secured to the fifth rod. The fifth dual axis clamps each slidably secure a sixth rod. The respective sixth rods may be used to positioned and support the fifth rod at different positions above the base. Rotation of each fifth dual axis clamp around the axis of the fifth rod and clamping of the respective sixth rods positions the sixth rods at any desired angle and height relative to the base.

In addition, an alternative embodiment of the universal holding fixture includes threaded machine screws that engage selected pairs of (second and third) dual axis clamps. The threaded machine screws may be tightened to pull rods contacting an object or workpiece toward each other to squeeze the object and securely hold it, such as in the manner of a vise.

The present invention has many applications in many fields of use, including medical, hobby, electronic, manufacturing and construction, for example. The present invention is not limited to use with only small objects, and may be sized to accommodate very large objects, such as boat, ship or airplane structures, for example. In particular, versions of the present fixture may be designed for use with vehicles, boats, ships. and airplanes, and components relating thereto, such as engines and vehicle components, as well as construction-related structures and components.

### BRIEF DESCRIPTION OF THE DRAWINGS

The various features and advantages of the present invention may be more readily understood with reference to the following detailed description taken in conjunction with the accompanying drawings wherein like reference numerals designate like structural elements, and in which:

FIG. 1 illustrates a first exemplary embodiment of a universal holding fixture in accordance with the principles of the present invention;

FIGS. 2a-2f show detailed views of dual axis clamps employed in the universal holding fixture shown in FIG. 1;

FIG. 3 illustrates a second exemplary embodiment of a universal holding fixture in accordance with the principles of the present invention; and

FIGS. 4a and 4b show detailed views of certain dual axis clamps employed in the universal holding fixture shown in FIG. 3.

### DETAILED DESCRIPTION

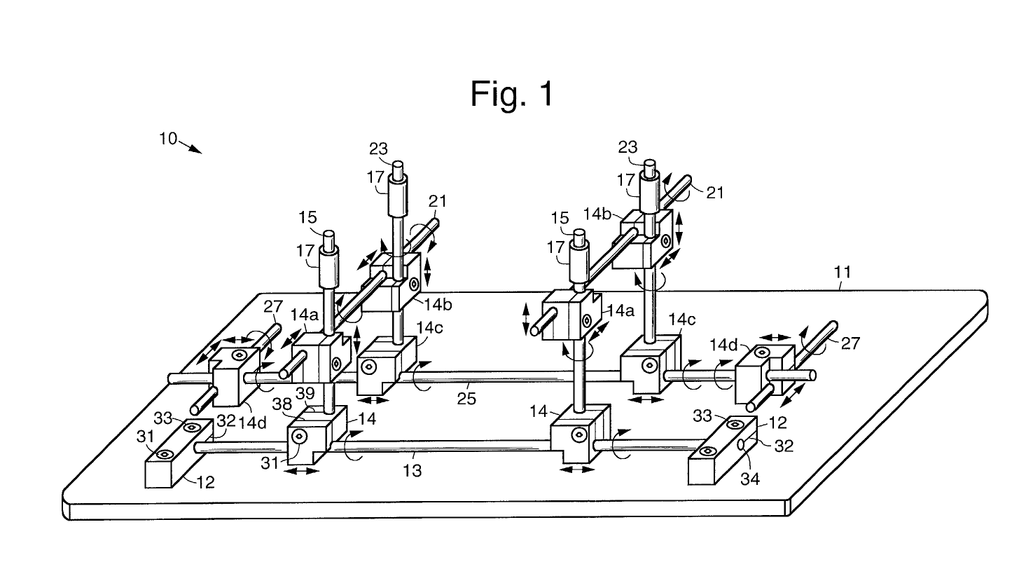

Referring to the drawing figures, FIG. 1 illustrates a first exemplary embodiment of a universal holding fixture 10 in accordance with the principles of the present invention. As is shown in FIG. 1, the exemplary universal holding fixture 10 comprises a base 11 to which a plurality of single axis clamps 12 are secured. Each of the single axis clamps 12 is secured to the base 11 using machine screws 31, for example, which engage a threaded hole (not shown) in the base 11. It is to be understood, however. that the base 11 may not be required in all embodiments of the present invention. For example, the single axis clamps 12 may be secured to a workbench, a wall, a floor, or any other suitable support structure.

The single axis clamps 12 secure a first rod 13 therebetween in a manner that allows the first rod 13 to be rotated and then secured in the rotated position. This may be accomplished by providing a hole through each single axis clamp 12, providing a slot 32 in the single axis clamp 12 that is aligned along the axis of the first rod 13, and providing a machine screw 33 that mates with a threaded hole 34 that tightens the single axis clamp 12 around the first rod 13. The machine screw 33 may also be used to secure the single axis clamps 12 to the base 11, which machine screw 33 engages a threaded hole (not shown) in the base 11.

A plurality of first dual axis clamps 14 are slidably secured to the first rod 13. Each of the first dual axis clamps 14 may be moved or slid along the first rod, independently rotated around the first rod 13, and secured in the moved and rotated position. Each of the first dual axis clamps 14 secures a second rod 15 that is aligned substantially orthogonal to the first rod 13. Rotation of each second rod 15 and first dual axis clamp 14 around or about the axis of the first rod 13 positions the second rod 15 at any desired angle.

A second dual axis clamp 14a is slidably secured to each of the second rods 15. Each second dual axis clamp 14a may be moved or slid along the second rod 15. independently rotated around or about the second rod 15, and secured in the moved and rotated position. Each of the second dual axis clamps 14a also secures a third rod 21 that is aligned substantially orthogonal to the second rod 15. Rotation of each third rod 21 and second dual axis clamp 14a around the axis of the second rod 15 positions the third rod 21 at any desired angle. Each of the second rods 15 may have a resilient member 17 slidably attached thereto that is positioned to contact an object or workpiece.

A third dual axis clamp 14b is slidably secured to each of the third rods 21. Each third dual axis clamp 14b may be moved or slid along the third rod 21, independently rotated around the third rod 21, and secured in the moved and rotated position. Each of the third dual axis clamps 14b also secures a fourth rod 23 that is aligned substantially orthogonal to the third rod 21. Rotation of each forth rod 23 and third dual axis clamp 14b around the axis of the third rod 21 positions the forth rod 23 at any desired angle. Each of the third rods 21 may have a resilient member 17 attached to ends thereof that contact a workpiece.

A forth dual axis clamp 14c is slidably secured to each of the forth rods 23 Each forth dual axis clamp 14c may be moved or slid along the forth rod 23. independently rotated around the forth rod 23, and secured in the moved and rotated position. Each of the forth dual axis clamps 14c also secures a fifth rod 25 that is aligned substantially orthogonal to the forth rods 23. Rotation of the fourth dual axis clamps 14c around the axis of each forth rod 23 positions the fifth rod 25 at any desired angle.

A plurality of fifth dual axis clamps 14d are slidably secured to the fifth rod 25. Each of the fifth dual axis clamps 14d may be moved or slid along the fifth rod 25, independently rotated around the fifth rod 25, and secured in the moved and rotated position. Each of the fifth dual axis clamps 14d secures a sixth rod 27 that is aligned substantially orthogonal to the fifth rod 25. Rotation of each sixth rod 27 and fifth dual axis clamp 14d around the axis of the fifth rod 25 positions the sixth rod 27 at any desired angle. The sixth rods 27 may be suitably positioned in the fifth dual axis clamps 14d and rotated vertically so that the fifth rod 25 is disposed at any suitable angle relative to the base 11 or first rod 13. The sixth rods 27 function as support rods, wherein the sixth rods 27 are rotated so that selected ends thereof contact the base 11 to hold an object or workpiece above the base 11.

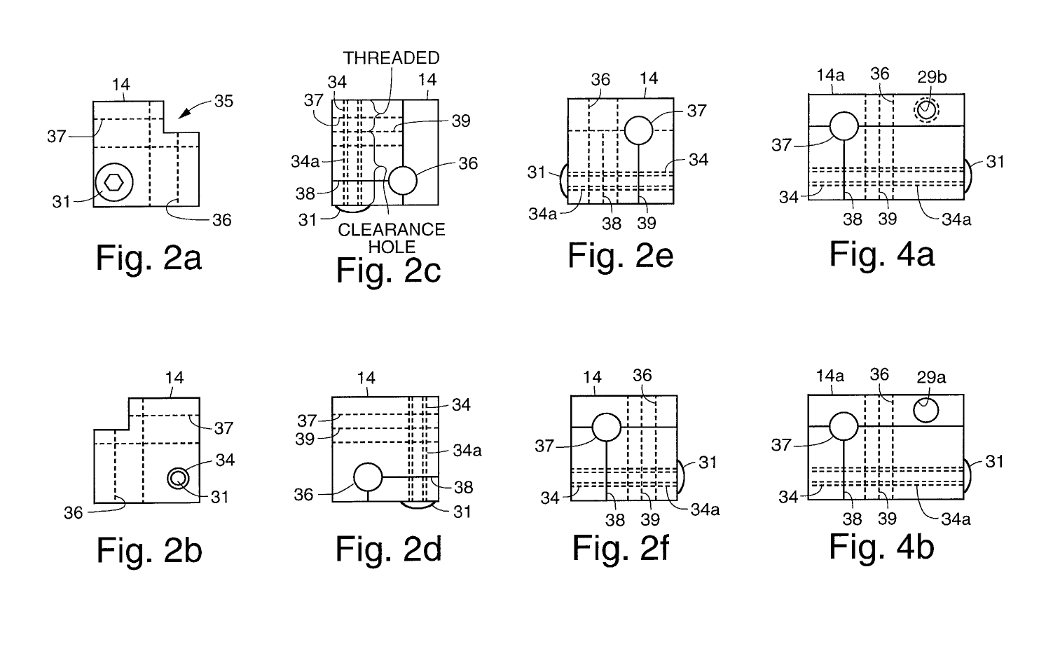

FIGS. 2a-2f show details of the dual axis clamps 14, 14a, 14b, 14c, 14d employed in the universal holding fixture 10 shown in FIG. 1. The dual axis clamps 14 are generally constructed in the shape of a cube, although this is not absolutely required. A portion 35 of each of the dual axis clamps 14, 14a, 14b, 14c, 14d is removed, although this is also not absolutely required. However, the second and third dual axis clamps 14a, 14b preferably have cutouts that permit a rectangular or square object to make contact with the rods 15, 21, 23.

Each of the dual axis clamps 14 has two orthogonal holes 36, 37 disposed therethrough. Slots 38, 39 are formed in the dual axis clamps 14 that extend from the respective orthogonal holes 36, 37 through the sidewall. A machine screw 31 is inserted thorough a clearance hole 34a that extends up to the slot 39. A threaded end of the machine screw 31 engages a threaded hole 34 extending through the remaining portion of the dual axis clamps 14 past the slot 39. Tightening of the machine screw 31 into the threaded hole 34 secures the respective rod 36, 37.

A number of arrows are shown in FIG. 1 that illustrate motion of the dual axis clamps 14, 14a, 14b, 14c, 14d along and around the respective rods 13, 15, 21, 23, 25. By appropriately sliding and rotating a each of the dual axis clamps 14, 14a, 14b, 14c, 14d the location or position of the ends of the (vertical as shown in FIG. 1) rods 15, 23 may be changed so that the rods 15, 23, or resilient members 17 if employed, contact various surfaces or portions of surfaces of a workpiece that is held by the holding fixture 10.

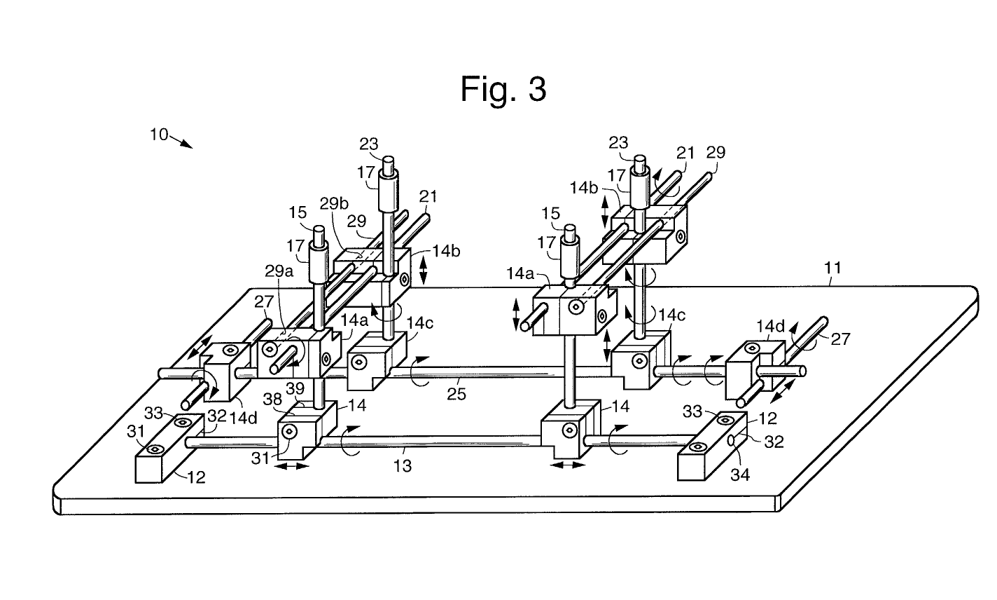

FIG. 3 illustrates a second exemplary embodiment of a universal holding fixture 10 in accordance with the principles of the present invention. This exemplary universal holding fixture 10 is substantially the same as the embodiment shown in FIG. 1 but further includes two threaded machine screws 29 that interconnect the upper pairs of dual axis clamps 14a, 14b. FIGS. 4a and 4b show detailed views of an upper pair of dual axis clamps 14a, 14b employed in the universal holding fixture shown in FIG. 3.

The threaded machine screws 29 extend through a clearance hole 29a (FIG. 4a) in the first dual axis clamp 14a and into a threaded hole 29b (FIG. 4b) in the second dual axis clamp 14b. Inserting the threaded machine screws 29 through the threaded hole 29b clearance holes 29a and tightening them in the threaded hole 29b threaded holes 29b allows an object to be tightly secured in the fixture 10, such as in the manner of a vise, for example.

Thus, universal holding fixtures or tools that are particularly well-adapted for use in holding oddly shaped workpieces have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A universal holding fixture for holding an object, comprising:
a plurality of dual axis clamps that are each rotatably and slidably secured to rods to form an articulated structure, and wherein selected rods are suitably positioned and secured to hold the object.

2. The fixture recited in claim 1 wherein selected ones of the dual axis clamps are secured to a base.

3. The fixture recited in claim 2 wherein a fixed rod is secured to the base and the articulated structure comprises eight dual axis clamps that are slidably secured to six rods.

4. The fixture recited in claim 3 further comprising two additional rods that are slidably secured to a selected one of the four rods by way of two additional dual axis clamps.

5. The fixture recited in claim 1 wherein the articulated structure comprises eight dual axis clamps that are slidably secured to six rods.

6. The fixture recited in claim 5 further comprising two additional rods that are slidably secured to a selected one of the four rods by way of two additional dual axis clamps.

7. The fixture recited in claim 1 wherein the articulated structure comprises:
a plurality of first dual axis clamps that are slidably and rotatably secured to a fixed rod and that are each slidably secured to a second transverse rod;
a plurality of second dual axis clamps that are slidably and rotatably secured to a respective second rod and that are each slidably and rotatably secured to a third rod that is disposed generally transverse to the respective second rod;
a plurality of third dual axis clamps that are slidably and rotatably secured to a respective third rod and that are each slidably and rotatably secured to a fourth rod that is disposed generally transverse to the respective third rod; and
a plurality of fourth dual axis clamps that are slidably and rotatably secured to a respective fourth rod and that are each slidably and rotatably secured to a fifth rod.

8. The fixture recited in claim 7 further comprising a plurality of fifth dual axis clamps that are slidably and rotatably secured to the fifth rod and that are each slidably secured to a sixth rod.

9. The fixture recited in claim 1 wherein plurality of first dual axis clamps are secured to a base and wherein the fixture further comprises a plurality of fifth dual axis clamps that are slidably and rotatably secured to the fifth rod and that are each slidably secured to a sixth rod, and wherein the sixth rods support the fifth rod at different positions above the base.

10. The fixture recited in claim 7 further comprising a plurality of threaded machine screws that interconnect pairs of second and third dual axis clamps.

11. A universal holding fixture for holding an object, comprising:
a base; and
an articulated structure secured to the base that comprises a plurality of dual axis clamps that are each rotatably and slidably secured to one or more rods, and wherein ends of selected ones of the rods are suitably positioned and secured to hold the object.

12. The fixture recited in claim 11 wherein a fixed rod is secured to the base and the articulated structure comprises eight dual axis clamps that are slidably secured to six rods.

13. The fixture recited in claim 12 further comprising two additional rods slidably secured to a selected one of the six rods by way of two additional dual axis clamps.

14. The fixture recited in claim 11 wherein the articulated structure comprises:
a plurality of first dual axis clamps that are slidably and rotatably secured to a fixed rod and that are each slidably secured to a second transverse rod;
a plurality of second dual axis clamps that are slidably and rotatably secured to a respective second rod and that are each slidably and rotatably secured to a third rod that is disposed generally transverse to the respective second rod;
a plurality of third dual axis clamps that are slidably and rotatably secured to a respective third rod and that are each slidably and rotatably secured to a fourth rod that is disposed generally transverse to the respective third rod; and
a plurality of fourth dual axis clamps that are slidably and rotatably secured to a respective fourth rod and that are each slidably and rotatably secured to a fifth rod.

15. The fixture recited in claim 14 further comprising a plurality of fifth dual axis clamps that are slidably and rotatably secured to the fifth rod and that are each slidably secured to a sixth rod.

16. The fixture recited in claim 14 further comprising a plurality of threaded machine screws that interconnect pairs of second and third dual axis clamps.

17. A universal holding fixture for holding an object, comprising:
a base; and
an articulated structure rotatably secured to the base that comprises:
a plurality of first dual axis clamps that are slidably and rotatably secured to a fixed rod and that are each slidably secured to a second transverse rod;
a plurality of second dual axis clamps that are slidably and rotatably secured to a respective second rod and that are each slidably and rotatably secured to a third rod that is disposed generally transverse to the respective second rod;
a plurality of third dual axis clamps that are slidably and rotatably secured to a respective third rod and that are each slidably and rotatably secured to a fourth rod that is disposed generally transverse to the respective third rod; and
a plurality of fourth dual axis clamps that are slidably and rotatably secured to a respective fourth rod and that are each slidably and rotatably secured to a fifth rod.

18. The fixture recited in claim 17 further comprising a plurality of fifth dual axis clamps that are slidably and rotatably secured to the fifth rod and that are each slidably secured to a sixth rod.

19. The fixture recited in claim 17 further comprising a plurality of threaded machine screws that interconnect pairs of second and third dual axis clamps.
